(19) United States
(12) Patent Application Publication
(10) Pub. No.: US 2005/0129404 A1
(43) Pub. Date: Jun. 16, 2005

(54) Apparatus for providing broadcasting service through overlay structure in WDM-PON

(76) Inventors: Byoung Whi Kim, Daejeon-city (KR); Seung Hyun Cho, Kyungki-do (KR); Hyeong Ho Lee, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/005,930

(22) Filed: Dec. 6, 2004

(30) Foreign Application Priority Data
Dec. 10, 2003 (KR) 2003-89360
Sep. 16, 2004 (KR) 2004-74217

(51) Int. Cl. H04J 14/02

(52) U.S. Cl. 398/84

(57) ABSTRACT

Provided is an apparatus for providing a broadcasting service through an overlay structure in a WDM-PON. The apparatus comprises: a first grating section receiving a multiplexed signal of N data communication optical wavelength signals and a broadcasting optical wavelength signal, which have separate wavelengths, transmitted from an optical line terminal (OLT) and wavelength-demultiplexing the multiplexed signal; a mirror reflecting the broadcasting optical wavelength signal wavelength-demultiplexed by the first grating section; and a second grating section receiving the reflected broadcasting optical wavelength signal and splitting it to all subscriber ports.

This application claims the priority of Korean Patent Application Nos. 2003-89360, filed on Dec. 10, 2003 and 2004-74217, filed on Sep. 16, 2004 in the Korean Intellectual Property Office, the disclosures of which are incorporated herein in their entirety by reference.

### BACKGROUND OF THE INVENTION

1. Field of the Invention

The present invention relates to an apparatus for providing a broadcasting service through an overlay structure in a wavelength division multiplexing passive optical network (WDM-PON).

2. Description of the Related Art

Since a WDM-PON system allocates a wavelength per user, the WDM-PON system is expected as a system suitable to provide a next generation fiber to the home (FTTH) service, which has a flexibility for various information services provided to each user.

The WDM-PON system has advantages as follows: 1) it is possible to provide a high speed service of more than 1 Gbps to each user since a dedicated wavelength is allocated to each user; 2) it is possible to expand the number of subscribers since the WDM-PON has a lower wavelength splitting loss as comparing with an optical power splitting of time division multiple access (TDMA) PON; and 3) complex control circuits for bandwidth control and timing synchronization is unnecessary since a plurality of users do not share a band in time.

A method for a subscribers network to accommodate a convergence service of data communication and broadcasting(C&B) has been being studied. Since WDM-PON structures suggested till now provide a separate large bandwidth to each subscriber, an in-band C&B integration method within a communication channel is presumed.

The in-band C&B integration method is considered as an optimal method for a convergence service in the WDM-PON system in terms of efficiency of a communication channel usage. However, it is predicted that it is difficult to deploy commercial services on the in-band integration method in the near future due to conflicts between communication providers and broadcasting providers and current communication laws. Considering this problem, an overlay method of providing a communication service and a broadcasting service via separate logical communication channels can be currently considered as an alternative plan.

### SUMMARY OF THE INVENTION

The present invention provides an apparatus for providing a communication service and a broadcasting service through an overlay structure in a WDM-PON.

According to an aspect of the present invention, there is provided an apparatus for providing a broadcasting service through an overlay structure in a WDM-PON, the apparatus comprising: a first grating section receiving a multiplexed signal of N data communication optical wavelength signals and a broadcasting optical wavelength signal, which have separate wavelengths, transmitted from an optical line terminal (OLT) and wavelength-demultiplexing the multiplexed signal; a mirror reflecting the broadcasting optical wavelength signal wavelength-demultiplexed by the first grating section; and a second grating section receiving the reflected broadcasting optical wavelength signal and splitting it to all output ports to subscribers.

According to another aspect of the present invention, there is provided an apparatus for providing a broadcasting service through an overlay structure in a WDM-PON, the apparatus comprising: a first grating section receiving a multiplexed signal of N data communication optical wavelength signals and a broadcasting optical wavelength signal, which have separate wavelengths, transmitted from an OLT and wavelength-demultiplexing the multiplexed signal; a second grating section multiplexing N upstream data optical wavelength signals and transmitting the multiplexed signal to the OLT; a mirror reflecting the broadcasting optical wavelength signal wavelength-demultiplexed by the first grating section; and a third grating section receiving the reflected broadcasting optical wavelength signal and splitting it to all subscriber ports.

According to another aspect of the present invention, there is provided an apparatus for providing a broadcasting service through an overlay structure in a WDM-PON, the apparatus comprising: an arrayed-waveguide grating (AWG) demultiplexing a multiplexed signal of N data communication optical wavelength signals and a broadcasting optical wavelength signal, which have separate wavelengths, transmitted from an OLT and transmitting the demultiplexed signals to all subscriber ports; and an optical power splitter splitting a signal focused on a focal position of the broadcasting optical wavelength signal in the AWG in order to split the broadcasting optical wavelength signal to a plurality of broadcasting optical wavelength signal output ports, wherein the split broadcasting optical wavelength signals are feedbacked to the AWG in order to evenly transmit the split broadcasting optical wavelength signals to the output ports.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates wavelength allocation in a WDM-PON providing a broadcasting service through an overlay structure;

FIG. 2A is a first configuration of a WDM-PON providing a broadcasting service through an overlay structure;

FIG. 2B illustrates in detail an example of a WDM MUX (WDM DMX) shown in FIG. 2A according to a first embodiment of the present invention;

FIG. 2C illustrates in detail another example of the WDM MUX (WDM DMX) shown in FIG. 2A according to a second embodiment of the present invention;

FIG. 3A is a second configuration of a WDM-PON providing a broadcasting service through an overlay structure;

FIG. 3B illustrates in detail an example of a WDM MUX (WDM DMX) shown in FIG. 3A according to a third embodiment of the present invention;

FIG. 3C illustrates in detail another example of the WDM MUX (WDM DMX) shown in FIG. 3A according to a fourth embodiment of the present invention;

FIG. 4 illustrates wavelength allocation in a WDM-PON providing a broadcasting service through an overlay structure when two wavelengths are allocated for broadcasting;

FIG. 5A is a third configuration of a WDM-PON providing a broadcasting service through an overlay structure;

FIG. 5B illustrates in detail an example of a WDM MUX (WDM DMX) shown in FIG. 5A according to a fifth embodiment of the present invention;

FIG. 5C illustrates in detail another example of the WDM MUX (WDM DMX) shown in FIG. 5A according to a sixth embodiment of the present invention;

FIG. 6A illustrates in detail a WDM MUX (WDM DMX) for providing a multicast broadcasting service according to a seventh embodiment of the present invention;

FIG. 6B illustrates in detail a WDM MUX (WDM DMX) for providing a multicast broadcasting service according to a eighth embodiment of the present invention;

FIG. 7A is a schematic configuration of an SCM/WDM-PON; and

FIG. 7B illustrates in detail the SCM/WDM-PON, which provides a broadcasting service through an overlay structure, shown in FIG. 7A.

### DETAILED DESCRIPTION OF THE INVENTION

Hereinafter, the present invention will now be described more fully with reference to the accompanying drawings, in which embodiments of the invention are shown. Like reference numbers are used to refer to like elements through at the drawings.

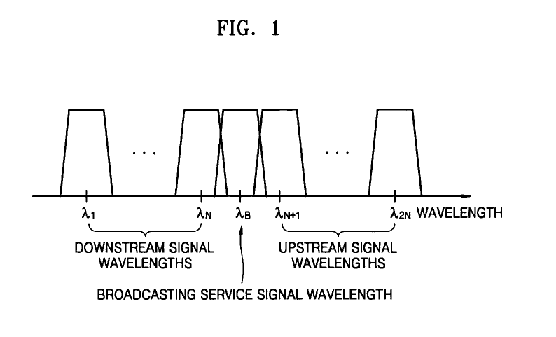

FIG. 1 illustrates wavelength allocation in a WDM-PON providing a broadcasting service through an overlay structure.

A broadcasting optical wavelength λ_{B} is allocated in the middle of wavelength bands (λ₁, . . . , λ_{N} for downstream, λ_{N+1}, . . . , λ_{2N} for upstream) allocated for downstream and upstream data communication.

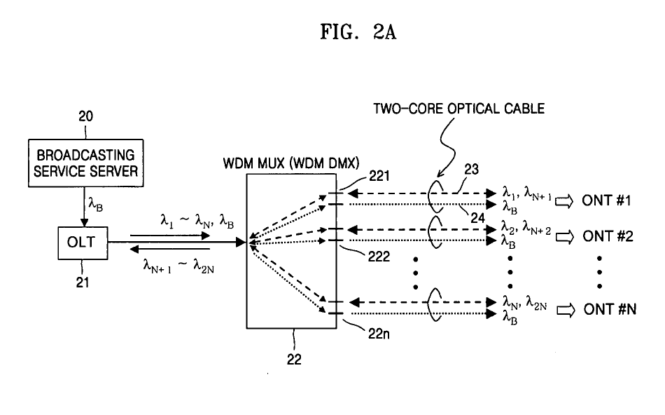

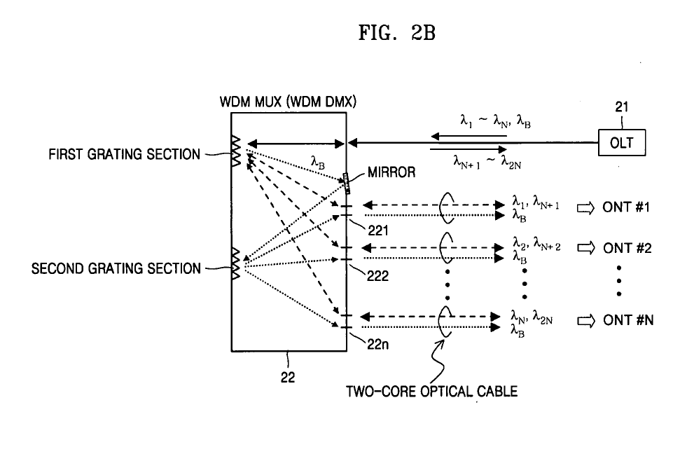

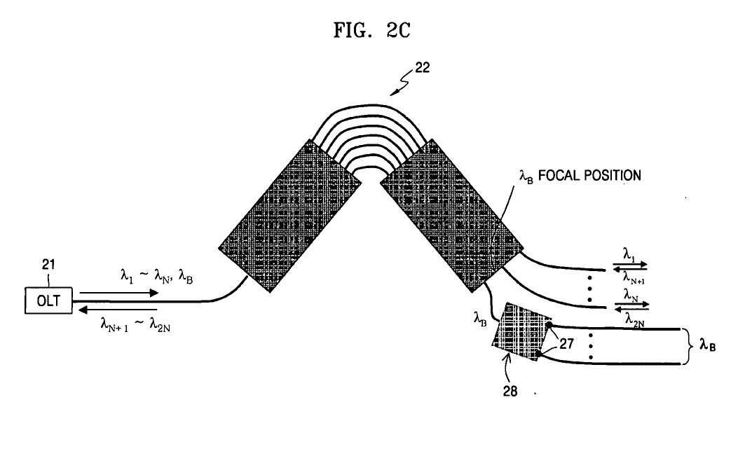

FIG. 2A is a first configuration of a WDM-PON providing a broadcasting service through an overlay structure according to a first embodiment of the present invention.

An OLT 21 receives a broadcasting optical wavelength λ_{B} on which broadcasting signals are carried from a broadcast server 20, multiplexes the broadcasting optical wavelength λ_{B} with downstream data communication optical wavelengths λ₁, . . . , λ_{N}, and transmits the multiplexed wavelengths to subscribers, i.e., an optical network terminal (ONT) #1 through an ONT #N. The broadcasting optical wavelength λ_{B} input to a WDM multiplexer/demultiplexer (MUX/DMX) 22 is split to all subscriber ports 221, 222, . . . , 22n, and the downstream data communication optical wavelengths λ₁, . . . , λ_{N} are transmitted to relevant subscribers by being wavelength-demultiplexed and transferred to relevant subscriber ports.

Upstream data communication optical wavelengths λ_{N+1}, . . . , λ_{2N} on which upstream data input from ONTs are carried are multiplexed by the WDM MUX/DMX 22 and transmitted to the OLT 21. The WDM MUX/DMX 22 corresponds to a remote node in the WDM-PON. Here, each subscriber port includes an optical fiber 23 for transmitting a data communication optical wavelength to bi-direction and an optical fiber 24 for transmitting a broadcasting optical wavelength to uni-direction, and these two optical fibers are wrapped in one two-core optical cable and connected to each ONT. Therefore, since each ONT performs diplex transmission in which an optical filter for separating data communication optical wavelengths and a broadcasting optical wavelength is unnecessary, costs can be reduced comparing with a triplex ONT providing a similar service.

As described above, a core component for realizing this embodiment is the WDM MUX/DMX 22, and a configuration of the WDM MUX/DMX 22 for providing a broadcasting service through an overlay structure is a core point.

FIG. 2B illustrates in detail an example of the WDM MUX/DMX 22 shown in FIG. 2A according to a first embodiment of the present invention.

Data communication optical wavelengths λ₁, . . . , λ_{N} and a broadcasting optical wavelength λ_{B} input from the OLT 21 are wavelength-demultiplexed by a first grating section. After wavelength-demultiplexing, the data communication optical wavelengths λ₁, . . . , λ_{N} are directly transmitted to relevant subscriber ports, and the broadcasting optical wavelength λ_{B} is reflected to a second grating section by a mirror. The reflected broadcasting optical wavelength λ_{B} is split to all subscriber ports by the second grating section.

That is, the first grating section operates as a MUX/DMX of input optical wavelengths, and the second grating section operates as a splitter splitting a broadcasting wavelength to subscriber ports.

Data communication optical wavelengths λ_{N+1}, . . . , λ_{2N} on which upstream data are carried are input from the ONTs, wavelength-multiplexed by the first grating section, and transmitted to the OLT 21 via a one-core optical cable. A bulk grating component or an Echelle grating component of an integrated optic type may be used as the first/second grating sections, and the latter is used in this embodiment.

FIG. 2C illustrates in detail another example of the WDM MUX (WDM DMX) 22 shown in FIG. 2A according to a second embodiment of the present invention.

A configuration shown in FIG. 2C adopts an arrayed-waveguide grating (AWG). Data communication optical wavelengths λ₁, . . . , λ_{N} and a broadcasting optical wavelength λ_{B} are demultiplexed by the AWG and transmitted to subscriber ports, and data communication optical wavelengths λ_{N+1}, . . . , λ_{2N} are multiplexed by the AWG and transmitted to the OLT 21. Here, since multiplexing and demultiplexing must be performed using one AWG, a free spectral range of the AWG is matched to using wavelength bands λ₁, . . . , λ_{N} and λ_{B}. If it is assumed that a grating order corresponding to the data communication optical wavelengths λ_{N+1}, . . . , λ_{2N} is m, a grating order corresponding to the data communication optical wavelengths λ₁, . . . , λ_{N} is m−1.

After a signal focused on a λ_{B} focal position to split the broadcasting optical wavelength λ_{B} to λ_{B} output ports 27 is split by an optical power splitter 28.

The AWG and the optical power splitter 28 can be manufactured using a semiconductor process after they are integrated on a single substrate made of silicon or silica and waveguides are formed using a substance such as polymer, silica, or silicon nitride.

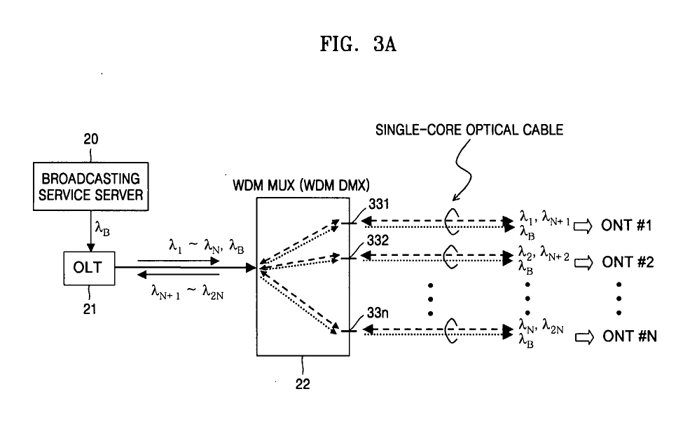

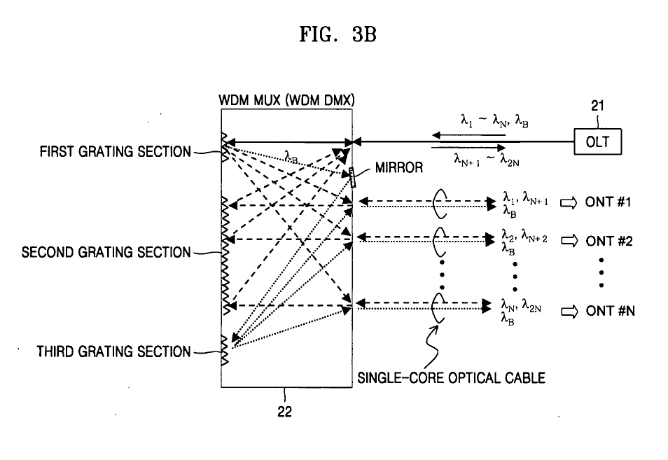

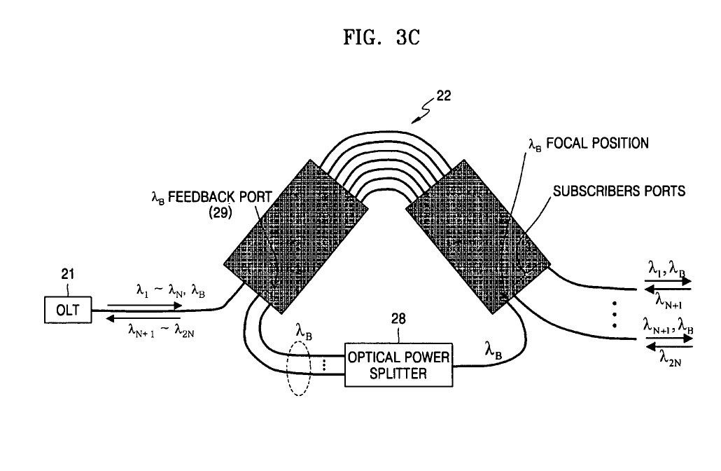

FIG. 3A is a second configuration of a WDM-PON providing a broadcasting service through an overlay structure.

Each of subscriber ports 331, 332, . . . , 33n transmits data communication optical wavelengths λ₁, . . . , λ_{N} and λ_{N+1}, . . . , λ_{2N} and a broadcasting optical wavelength λ_{B} to bi-direction using one optical fiber (single-core optical cable). Since the single-core optical cable is used, each ONT needs an optical filter for separating the data communication optical wavelengths λ₁, . . . , λ_{N} and the broadcasting optical wavelength λ_{B} unlike the method suggested in FIG. 2A. Since the other configuration and operations are equal to those of FIG. 2A, the other description is omitted.

FIG. 3B illustrates in detail an example of the WDM MUX (WDM DMX) 22 shown in FIG. 3A according to a third embodiment of the present invention.

Input multiplexed optical wavelengths λ₁, . . . , λ_{N} and λ_{B} are wavelength-demultiplexed by a first grating section. The data communication optical wavelengths λ₁, . . . , λ_{N} are directly transmitted to relevant subscriber ports. The broadcasting optical wavelength λ_{B} is diffracted by the first grating section and reflected to a third grating section by a mirror. The reflected broadcasting optical wavelength λ_{B} is split(copied) to all subscriber ports by the third grating section.

Upstream data communication optical wavelengths λ_{N+1}, . . . , λ_{2N} are input from ONTs, wavelength-multiplexed by a second grating section, and transmitted to an OLT 21 via a single-core optical cable.

FIG. 3C illustrates in detail another example of the WDM MUX (WDM DMX) 22 shown in FIG. 3A according to a fourth embodiment of the present invention.

Like the configuration of FIG. 2C, a configuration suggested in FIG. 3C adopts an AWG. After a signal focused on a λ_{B} focal position to split a broadcasting optical wavelength λ_{B} to λB output ports is split by an optical power splitter 28, the split broadcasting optical wavelengths λ_{B} are feedbacked to the AWG via λ_{B} feedback ports 29. In order to evenly split the broadcasting optical wavelength λ_{B} to the λ_{B} output ports, an interval of the λ_{B} feedback ports 29 is set same as an interval of the λ_{B} output ports, and each position of the λ_{B} feedback ports 29 can be obtained by an AWG design principle.

Referring to FIG. 3C, a region in which waveguides are crossed each other exists. However, according to experiments or theories, if a crossing angle between waveguides is above around 30°, a coupling between waveguides can be ignored. The AWG and the optical power splitter 28 can be manufactured using a semiconductor process after they are integrated on a single substrate made of silicon or silica and waveguides are formed using a material such as polymer, silica, or silicon nitride. Since the λ_{B} feedback ports 29 are located below a data input port, data communication optical wavelengths λ₁, . . . , λ_{N} and the broadcasting optical wavelength λ_{B} can be simultaneously transmitted to subscriber ports.

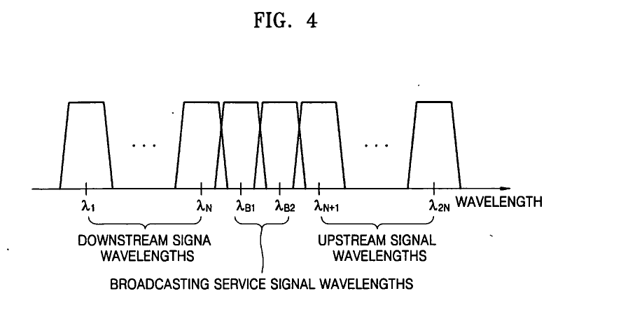

FIG. 4 illustrates wavelength allocation in a WDM-PON providing a broadcasting service through an overlay structure when two wavelengths are allocated for broadcasting. FIG. 4 is equal to FIG. 1 but two allocated broadcasting optical wavelengths. FIG. 4 shows that two wavelengths are allocated for broadcasting. However, it will be understood by those skilled in the art that more than two wavelengths can be allocated for broadcasting. A broadcasting service can be expanded by allocating a plurality of wavelengths.

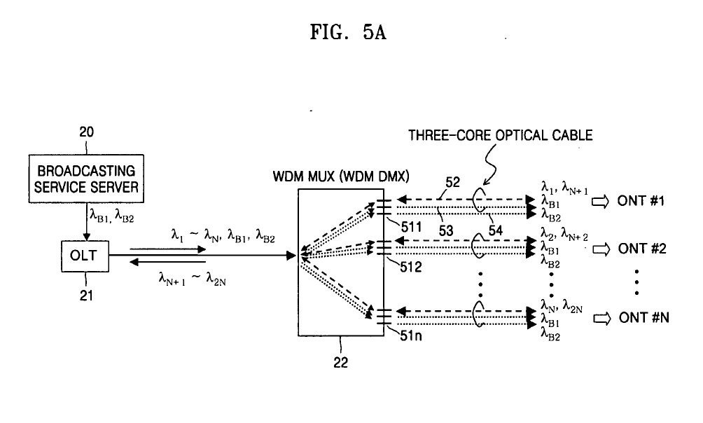

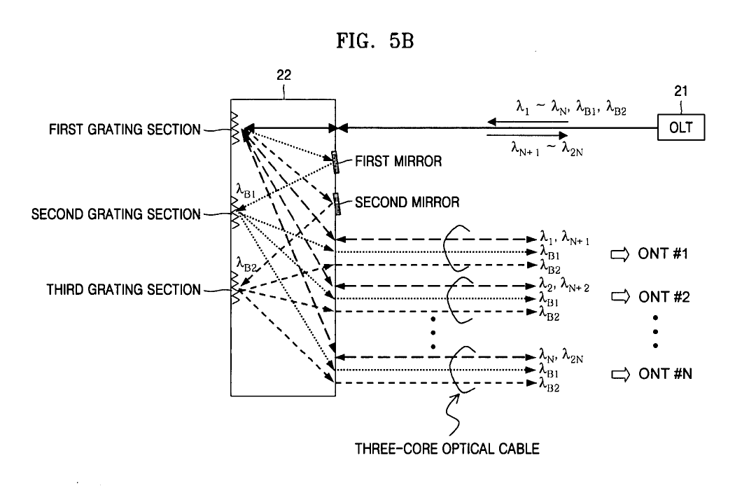

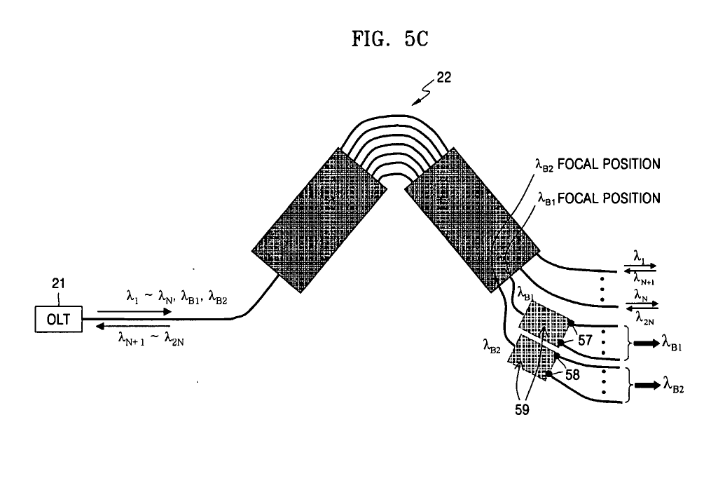

FIG. 5A is a third configuration of a WDM-PON providing a broadcasting service through an overlay structure.

An OLT 21 receives broadcasting optical wavelengths λ_{B1} and λ_{B2} on which broadcasting signals are carried from a broadcast server 20, multiplexes the broadcasting optical wavelengths λ_{B1} and λ_{B2} with downstream data communication optical wavelengths λ₁, . . . , λ_{N} and transmits the multiplexed wavelengths λ₁, . . . , λ_{B1} and λ_{B2} to subscribers, i.e., an ONT #1 through an ONT #N, through a WDM DMX 22. The broadcasting optical wavelengths λ_{B1} and λ_{B2} input to the WDM DMX 22 are split to all subscriber ports 511, 512, . . . , 51n, and the downstream data communication optical wavelengths λ₁, . . . , λ_{N}, are transmitted to relevant subscribers by being wavelength-demultiplexed and transferred to relevant subscriber ports.

Upstream data communication optical wavelengths λ_{N+1}, . . . , λ_{2N} input from the ONTs are multiplexed by the WDM MUX 22 and transmitted to the OLT 21. Each subscriber port includes an optical fiber 52 for transmitting a data communication optical wavelength to bi-direction and optical fibers 53 and 54 for transmitting respective broadcasting optical wavelengths λ_{B1} and λ_{B2} to uni-direction, and these three optical fibers are wrapped in one three-core optical cable and connected to each ONT. Therefore, since each ONT performs diplex transmission in which an optical filter for separating data communication optical wavelengths and a broadcasting optical wavelength is unnecessary, costs can be reduced comparing with a triplex ONT providing a similar service.

FIG. 5B illustrates in detail an example of a WDM MUX (WDM DMX) shown in FIG. 5A according to a fifth embodiment of the present invention.

Data communication optical wavelengths λ₁, . . . , λ_{N} and broadcasting optical wavelengths λ_{B1} and λ_{B2} input from the OLT 21 are wavelength-demultiplexed by a first grating section. After wavelength-demultiplexing, the data communication optical wavelengths λ₁, . . . , λ_{N} are directly transmitted to relevant subscriber ports, the broadcasting optical wavelength λ_{B1} is reflected to a second grating section by a first mirror, and the broadcasting optical wavelength λ_{B2} is reflected to a third grating section by a second mirror. The reflected broadcasting optical wavelength λ_{B1} and λ_{B2} are split to all subscriber ports by the second grating section and the third grating section.

That is, the first grating section operates as a MUX/DMX of input optical wavelengths, the second grating section operates as a splitter splitting the broadcasting wavelength λ_{B1} to all subscriber ports, and the third grating section operates as a splitter splitting the broadcasting wavelength λ_{B2} to all subscriber ports.

Data communication optical wavelengths λ_{N+1}, . . . , λ_{2N} on which upstream data are carried are input from the ONTs, wavelength-multiplexed by the first grating section, and transmitted to the OLT 21 via a one-core optical cable. As described in FIG. 2A, a bulk grating component or an Echelle grating component of an integrated optic type may be used as the first through third grating sections, and the latter is used in this embodiment.

FIG. 5C illustrates in detail another example of the WDM MUX (WDM DMX) shown in FIG. 5A according to a sixth embodiment of the present invention.

Like the configuration of FIG. 2C, a configuration suggested in FIG. 5C adopts an AWG. Data communication optical wavelengths λ₁, . . . , λ_{N} and broadcasting optical wavelength λ_{B1} and λ_{B2} are demultiplexed by the AWG and transmitted to subscriber ports, and data communication optical wavelengths λ_{N+1}, . . . , λ_{2N} are multiplexed by the AWG and transmitted to the OLT 21. Here, since multiplexing and demultiplexing must be performed using one AWG, a free spectral range of the AWG is matched to using wavelength bands λ₁, . . . , λ_{N}, λ_{B1} and λ_{B2}. If it is assumed that a grating order corresponding to the data communication optical wavelengths λ_{N+1}, . . . , λ_{2N} is m, a grating order corresponding to the data communication optical wavelengths λ₁, . . . , λ_{N} is m−1.

In order to split the broadcasting optical wavelengths λ_{B1} and λ_{B2} to λ_{B1} output ports 57 and λ_{B2} output ports 58, signals focused on a λ_{B1} focal position and a λ_{B2} focal position are split by an optical power splitter 59. The AWG and the optical power splitter 59 can be manufactured using a semiconductor process after they are integrated on a single substrate made of silicon or silica and waveguides are formed using a material such as polymer, silica, or silicon nitride.

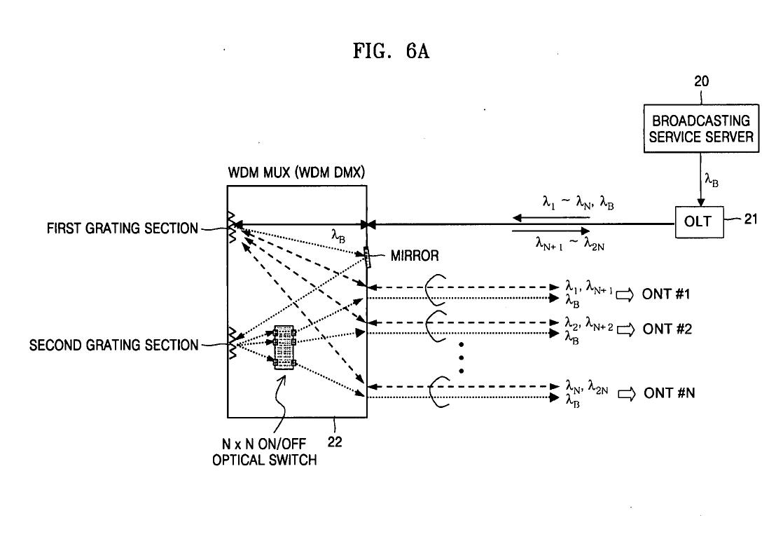

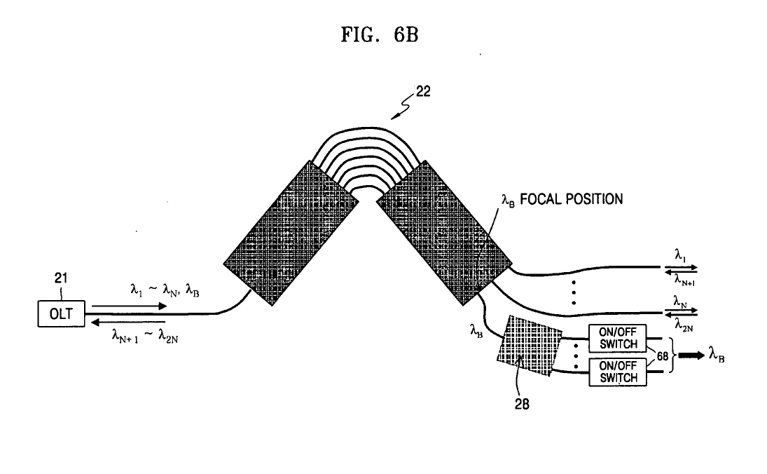

FIG. 6A illustrates in detail a WDM MUX (WDM DMX) for providing a multicast broadcasting service according to a seventh embodiment of the present invention.

While the broadcasting services in the embodiments described above adopt a broadcasting method of providing a broadcasting service to all subscribers, the present embodiment adopts a WDM MUX/DMX structure for a multicasting method of providing a broadcasting service to only specific subscribers. A basic configuration and operations are equal to those described in FIG. 2B but a usage of an N×N on/off optical switch. That is, a broadcasting service is provided to only specific subscribers by inserting the N×N on/off optical switch on optical paths of broadcasting optical wavelengths λ_{B} between a second grating section and ouput ports to users. A thermo-optic switch, a mechanical switch, or an acousto-optic switch can be used as the N×N on/off optical switch, and the N×N on/off optical switch is combined with a WDM MUX/DMX 22 as a hybrid type.

FIG. 6B illustrates in detail a WDM MUX (WDM DMX) for providing a multicast broadcasting service according to a eighth embodiment of the present invention.

A basic configuration and operations are equal to those described in FIG. 2C but a usage of on/off optical switches 68. That is, a broadcasting service is provided to only specific subscribers by inserting the on/off optical switches 68 at λ_{B} output ports 67. The on/off optical switches 68 are preferably a thermo-optic switch type, which can be integrated on a silicon or silica substrate. A substance, which can be used to manufacture the thermo-optic switch, is silica, polymer, or silicon nitride.

The methods of providing a broadcasting service through an overlay structure described above have advantages described above. However, the number of subscribers who can be accommodated per optical fiber is limited by the number of multiplexed optical wavelengths. Therefore, the methods can be a good solution for subscribers needing a large bandwidth more than 1 Gbps. However, the methods are unnecessary for subscribers needing a narrow bandwidth of around 100 Mbps.

Considering this problem, the present invention suggests a method of modulating data on a radio frequency (RF) carrier between hundreds MHz and one point some GHz and transmitting the modulated data by being carried on an optical wavelength. This method is called a sub-carrier multiplexing access (SCMA) method, and independent communication channels can be formed by allocating different RF carriers to the same optical wavelength using this method. Since the number of subscribers to be accommodated increases as many as a multiple number of the number of RF carriers allocated per optical wavelength, a subscriber accommodation capacity can be expanded.

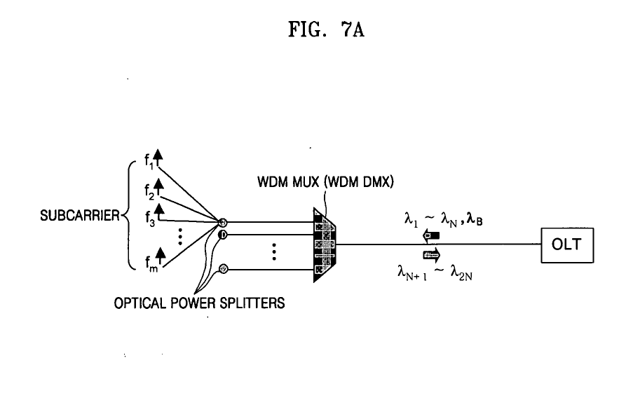

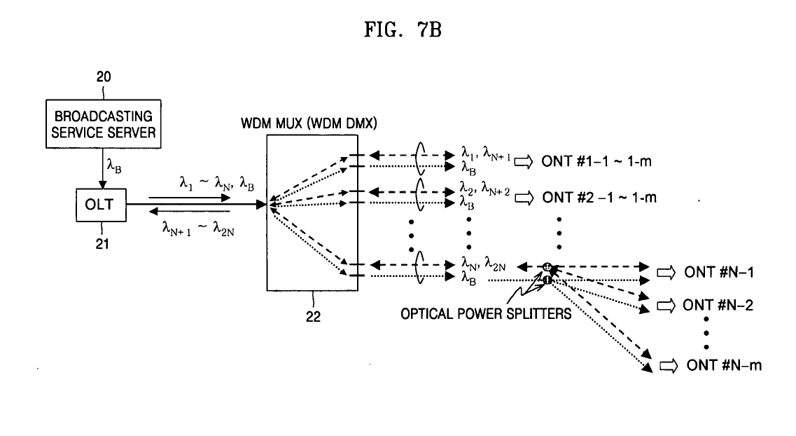

FIG. 7A is a schematic configuration of an SCM/WDM-PON.

In the present configuration, a multiplexing density increases by dividing a same optical wavelength into RF carriers. A plurality of subscribers uses the same optical wavelength by locating an optical power splitter between a WDM MUX/DMX 22 and the subscribers. The subscribers using the same optical wavelength have separate communication channels by using different RF carriers f₁, . . . , fₘ.

FIG. 7B illustrates in detail the SCM/WDM-PON, which provides a broadcasting service through an overlay structure, shown in FIG. 7A. A basic configuration and operations are equal to those described in FIG. 2A but a usage of optical power splitters. That is, a plurality of ONTs (m ONTs in FIG. 7B) use the same optical wavelength by inserting the optical power splitters between a WDM MUX/DMX 22 and subscribers.

As described above, the present invention can cost-effectively provide a broadcasting channel of an overlay type to subscribers with advantages of a WDM-PON. The present invention also can be applied to a network in which communication channels are formed by dividing a same optical wavelength into RF carriers once more.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. An apparatus for providing a broadcasting service through an overlay structure in a WDM-PON, the apparatus comprising:
a first grating section receiving a multiplexed signal of N data communication optical wavelength signals and a broadcasting optical wavelength signal, which have separate wavelengths, transmitted from an optical line terminal (OLT) and wavelength-demultiplexing the multiplexed signal;
a mirror reflecting the broadcasting optical wavelength signal wavelength-demultiplexed by the first grating section; and
a second grating section receiving the reflected broadcasting optical wavelength signal and splitting it to all output ports to subscribers.

2. The apparatus of claim 1, wherein each of the output ports to subscribers uses a two-core optical cable composed of an optical fiber for transmitting the data communication optical wavelength signals to bi-direction and an optical fiber for transmitting the broadcasting optical wavelength signal to uni-direction.

3. The apparatus of claim 1, wherein a broadcasting service can be expanded by preparing the mirror and the second grating section as many as the number of allocated wavelengths of the broadcasting optical wavelength signal when a plurality of allocated wavelengths of the broadcasting optical wavelength signal are allocated to the apparatus.

4. The apparatus of claim 1, wherein the broadcasting service is provided to only specific subscribers by inserting an optical switch on optical paths of broadcasting optical wavelength signals between the second grating section and the output ports to subscribers.

5. An apparatus for providing a broadcasting service through an overlay structure in a WDM-PON, the apparatus comprising:
a first grating section receiving a multiplexed signal of N data communication optical wavelength signals and a broadcasting optical wavelength signal, which have separate wavelengths, transmitted from an OLT and wavelength-demultiplexing the multiplexed signal;
a second grating section multiplexing N upstream data optical wavelength signals and transmitting the multiplexed signal to the OLT;
a mirror reflecting the broadcasting optical wavelength signal wavelength-demultiplexed by the first grating section; and
a third grating section receiving the reflected broadcasting optical wavelength signal and splitting it to all output ports to subscribers.

6. The apparatus of claim 5, wherein each of the output ports to subscribers uses a single-core optical cable composed of an optical fiber for transmitting the data communication optical wavelength signal and the broadcasting optical wavelength signal.

7. The apparatus of one of claims 1 or claim 5, wherein a plurality of subscribers share one optical wavelength signal of the N data communication optical wavelength signals and one broadcasting optical wavelength signal of one subscriber port of the all subscriber ports by further comprising optical power splitter splitting the one optical wavelength signal by modulating the signal into different RF carriers and splitting the one broadcasting optical wavelength signal by modulating the signal into different RF carriers.

8. An apparatus for providing a broadcasting service through an overlay structure in a WDM-PON, the apparatus comprising:
an arrayed-waveguide grating (AWG) demultiplexing a multiplexed signal of N data communication optical wavelength signals and a broadcasting optical wavelength signal, which have separate wavelengths, transmitted from an OLT and transmitting the demultiplexed signals to all output ports to subscribers; and
an optical power splitter splitting a signal focused on a focal position of the broadcasting optical wavelength signal in the AWG in order to split the broadcasting optical wavelength signal to a plurality of broadcasting optical wavelength signal output ports.

9. The apparatus of claim 8, wherein the split broadcasting optical wavelength signals are evenly transmitted to the output ports by feedbacking the split broadcasting optical wavelength signals to the AWG.

10. The apparatus of claim 8, wherein a broadcasting service can be expanded by further installing the optical power splitters as many as an allocated number when a plurality of wavelengths of the broadcasting optical wavelength signal are allocated.

11. The apparatus of claim 8, wherein the broadcasting service is provided to specific subscribers by inserting optical switches at the output ports.

12. The apparatus of one of claims 8, wherein a plurality of subscribers share each of the N data communication optical wavelengths by further comprising optical wavelength splitters splitting the one optical wavelength signal by modulating the signal into different RF carriers.
